(19) United States
(12) Patent Application Publication
(10) Pub. No.: US 2022/0125237 A1
(43) Pub. Date: Apr. 28, 2022

(54) SPOUTED LIQUID CONTAINER AND ASSOCIATED METHODS

(71) Applicant: TITAN DIRECT, LLC, Austin, TX (US)

(72) Inventor: Michael Edward CASEY, Austin, TX (US)

(21) Appl. No.: 17/452,449

(22) Filed: Oct. 27, 2021

Related U.S. Application Data
(60) Provisional application No. 63/106,170, filed on Oct. 27, 2020.

(51) Int. Cl. A47J 36/14; A47J 36/08

(52) U.S. Cl. CPC A47J 36/14; A47J 36/08

(57) ABSTRACT

Spouted liquid containers and associated methods are described herein. In one aspect, a spouted container can include a container body having a bottom surface and a sidewall, where the bottom surface and the sidewall define a cavity, where the sidewall further defines an aperture; a spout coupled to the sidewall via a proximal end and in fluidic communication with the cavity via the aperture; and a mesh screen coupled to the sidewall and positioned to encompass the aperture.

### CROSS-REFERENCE TO RELATED APPLICATIONS

This application is based on, and claims priority to, U.S. Provisional Application No. 63/106,170, titled “A unique and novel way to drain hot liquids from a cooking device by attaching a drain spout to the lower portion of the device for the purpose of tilting and draining during or after the cooking process without removing the food,” filed on Oct. 27, 2020, the entire contents of which being fully incorporated herein by reference.

### BACKGROUND OF THE INVENTION

Draining unwanted liquids from a container can be troublesome and potentially dangerous. For example, draining bacon or meat grease from a hot pan can be troublesome and cause a mess and sometimes burns. The same can be said for boiling pasta water. Current pans force the user to tilt the lid so far over that food spills out with the grease or water. Alternatively, a user can empty the contents of a pan into a colander for draining; however, this increases the number of dishes in use, as well as increases the time for the overall cooking process (having to drain via the colander, having to clean the colander, and the like).

It would be desirable to integrate a spout with a container to enable safe removal of grease, hot water, or other liquids without interrupting the cooking process.

### SUMMARY

Spouted liquid containers and associated methods are described herein. In one aspect, a spouted container can include a container body having a bottom surface and a sidewall, where the bottom surface and the sidewall define a cavity, where the sidewall further defines an aperture; a spout coupled to the sidewall via a proximal end and in fluidic communication with the cavity via the aperture; and a mesh screen coupled to the sidewall and positioned to encompass the aperture.

This aspect can include a variety of embodiments. In one embodiment, the sidewall terminates at an edge distally away from the bottom surface. In some cases, the spouted container can further include a lid configured to be coupled to the edge of the sidewall. In some cases, the pivoting cover is further configured to cease contacting the distal end of the spout when the lid is coupled to the container body and the spouted container is in a draining position. In some cases, the draining position includes a rotation of the container such that the distal end of the spout is at a lower height than the edge of the sidewall. In some cases, the spouted container further includes a lid locking mechanism coupled to the lid, where the lid locking mechanism is configured to engage a corresponding locking mechanism coupled to the container body when the lid is coupled to the edge of the sidewall, and where the lid is secured to the container body when the lid locking mechanism is engaged with the corresponding locking mechanism.

In another embodiment, the bottom surface and sidewall are composed of a non-stick, food-grade material.

In another embodiment, the container body can be a cooking pan or a cooking pot.

### BRIEF DESCRIPTION OF THE DRAWINGS

FIG. 1 is an exploded view of a cooking system with an integrated spout according to an embodiment of the present disclosure.

FIG. 2 is a perspective view of a cooking system with an integrated spout according to an embodiment of the present disclosure.

FIG. 3 is a top perspective view of a cooking system with an integrated spout according to an embodiment of the present disclosure.

FIG. 4 is a bottom perspective view of a cooking system with an integrated spout according to an embodiment of the present disclosure.

FIGS. 5-8 are side perspective views of a cooking system with an integrated spout according to an embodiment of the present disclosure.

FIG. 9 is an exploded view of a cooking system with an integrated spout according to an embodiment of the present disclosure.

FIG. 10 is a perspective view of a cooking system with an integrated spout according to an embodiment of the present disclosure.

FIGS. 11-14 are side perspective views of a cooking system with an integrated spout according to an embodiment of the present disclosure.

FIG. 15 is a top perspective view of a cooking system with an integrated spout according to an embodiment of the present disclosure.

FIG. 16 is a bottom perspective view of a cooking system with an integrated spout according to an embodiment of the present disclosure.

FIG. 17 is an exploded view of a cooking system with an integrated spout according to an embodiment of the present disclosure.

FIG. 18 is a perspective view of a cooking system with an integrated spout according to an embodiment of the present disclosure.

### DETAILED DESCRIPTION

According to an embodiment of the present disclosure, a spout can be integrated into a container body. The spout allows the user to safely tilt and drain any liquids held within the container without removing any solids within the container or spilling the liquids over the container's edge. The spout can also save the user from having to use other complementary devices for draining the container's contents, such as a colander for food products.

In the context of a cooking pot, the spout prevents food spillage and dangerous grease or hot water from spilling over when users try to use the conventional method of simply tilting and pouring liquids out of the top of the pan.

The spout of the present disclosure provides a safe way to dispose of grease or hot water without interrupting the cooking process. In some cases, the spouted container can eliminate the need for ladling of volumes contained in the container. For example, when draining gravies, soups, melted butter, and the like, a user can now go directly from the spout container to a another dish (soup into a bowl, gravy over mashed potatoes, melted butter over popcorn, melted chocolate over desserts, etc.), without the need for using a ladle.

The spout can also be integrated into other types of containers. For example, a spout can be integrated into a container that is used in medical labs for draining hot or dangerous liquids from other devices. A spout according to the claimed invention can also be integrated into paint cans and other containers where pouring liquids from them can traditionally cause drippage or spillage.

### Spouted Liquid Container:

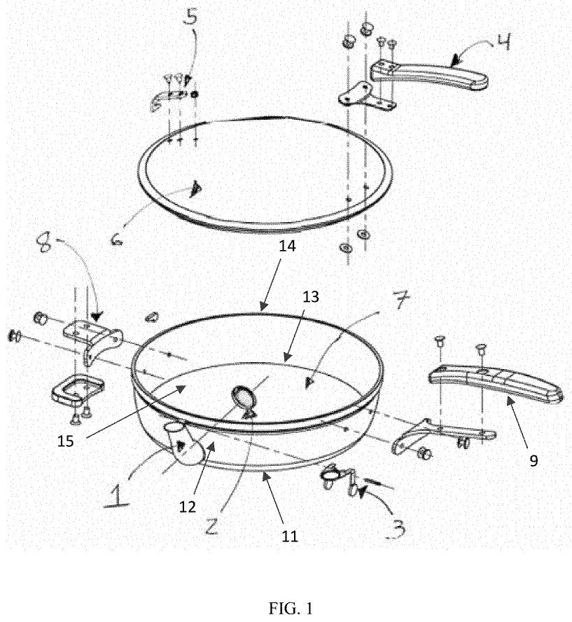

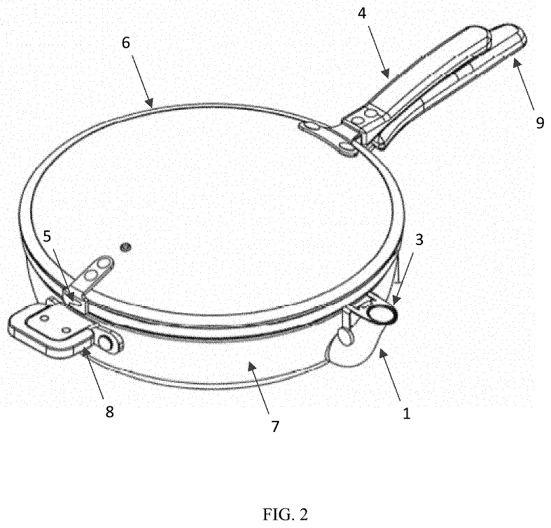

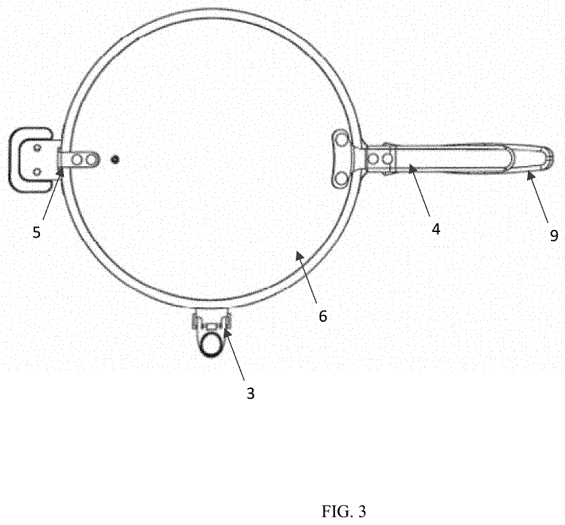

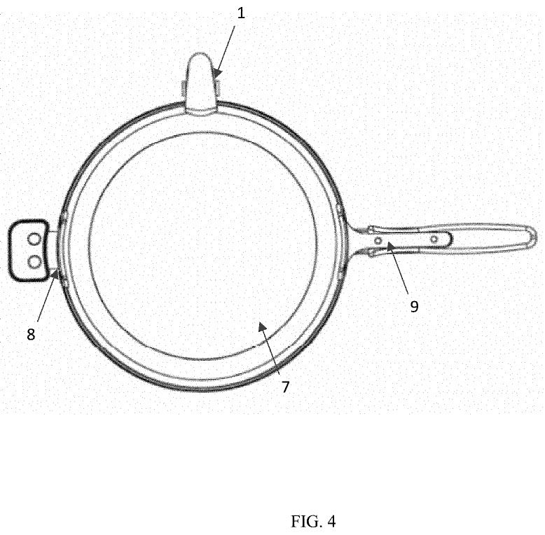

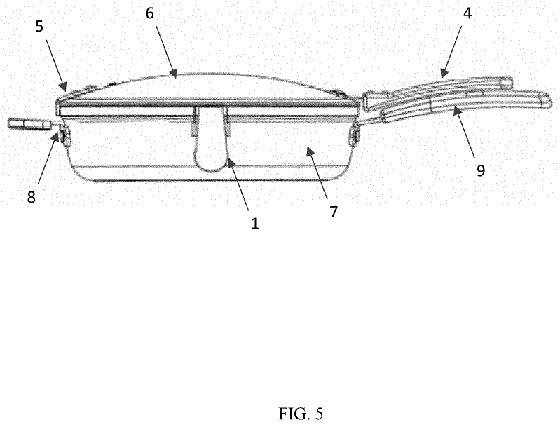

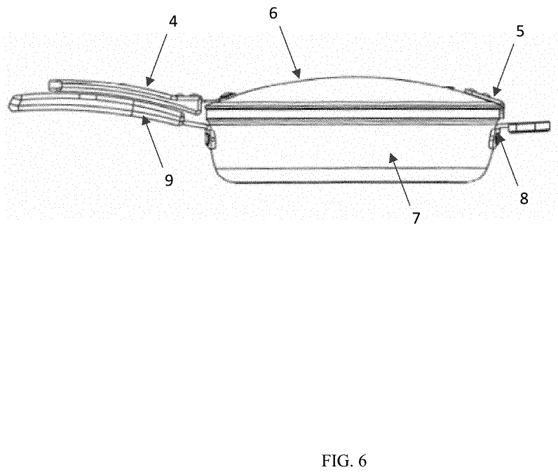

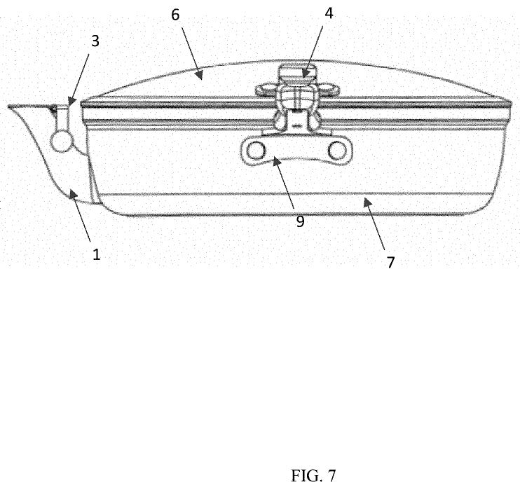

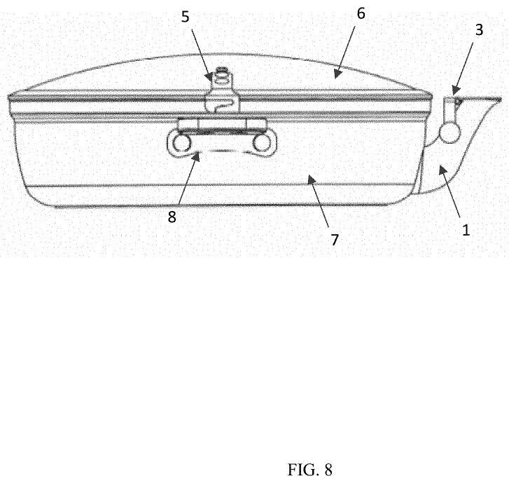

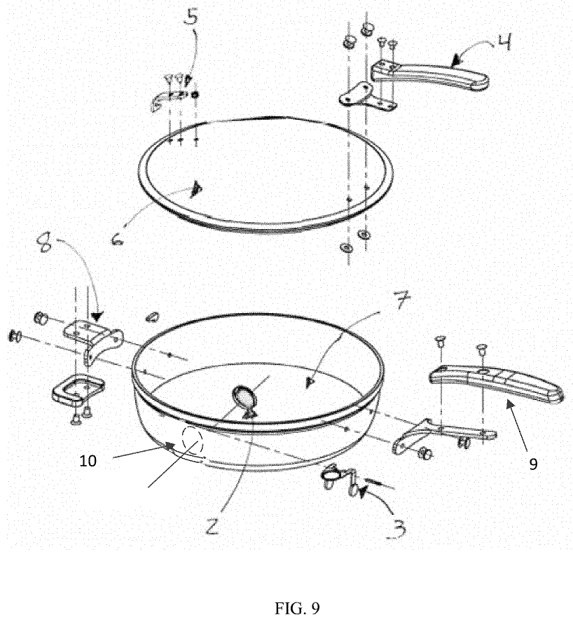

FIG. 1 depicts an exploded view of a spouted container according to an embodiment of the present disclosure. The spouted container can be, for example, a cooking pot or pan.

The spouted container can include a container body 7. The container body 7 can define a bottom surface 11, and at least one sidewall 12. The sidewall 12 can include an edge 13 coupled to the edge of the bottom surface 11, and can include another edge distally away from the bottom surface 11 that terminates to form a lip 14. The sidewall 12 can be continuous, thereby enclosing the entire outer perimeter (e.g., circumference) of the bottom surface 11. The bottom surface 11 and the sidewall 12 also define a cavity 15. Further, the bottom surface 11 and the sidewall 12 can be formed of a single layer of material, or multiple layers of material. For example, in the context of a cooking pan, the sidewall 12 and bottom surface 11 defining the cavity 15 can be composed of a stick-resistant surface, a scratch-resistant surface, and the like. However, other layers of material can be layered with the surfaces defining the cavity 15, such as non-food grade materials covering the exterior portions of the cooking pan. When the container is in use, the container can retain a volume of liquid and/or solid within the cavity 15.

The spouted container can include a spout 1. The spout 1 can attach to the exterior of a container body 7. The spout 1 can be attached to the sidewall 12 of the container body 7. For example, an aperture 10 can be defined by the sidewall 12 of the container body 7, which can be approximately the size and shape of a proximal end of the spout 1. The spout 1 can be inserted into the aperture 10, or can be coupled to the adjacent portions of the sidewall 12 immediately defining the aperture 10 (e.g., with a gasket, an o-ring, or the like, coupled to the proximal end of the spout 1 and the sidewall 12). In some cases, the spout 1 can be formed during the creation of the container body 7, for example, through a casting process. In some cases, the spout 1 can be configured for a portion of the spout 1 to be positioned within the cavity 15 when inserted into the aperture 10. For example, the proximal end of the spout 1 can be barbed, such that when inserted into the aperture 10, the barbs prevent the spout from slipping out of the aperture 10. In other cases, the proximal end can be threaded, and a nut can be fastened onto the proximal end after insertion into the aperture 10. In some cases, the spout 1 can be composed of the same material as the container body 7, for example, stainless steel or aluminum. In some cases, the spout 1 can include layered materials similar to those described above for the container body 7.

The spout 1 can form a shape that facilitates the draining of liquids from the container body 7. For example, the spout 1 can extend distally away from the sidewall 12. In some cases, the spout 1 can be different shapes and sizes. For example, the spout shown in FIG. 1 initially extends away from the sidewall 12 in an almost perpendicular fashion from the sidewall 12, and then extends upward in an almost parallel fashion from the sidewall 12. Further, the cross-section size of the spout 1 (e.g., along its axis of symmetry) can change along the length of the spout 1. For example, as shown in FIG. 1, the spout 1 tapers distally away from the sidewall 12, such that the distal end has a smaller cross-section as compared to the proximal end. However, a person having ordinary skill in the art will understand that the spout 1 can include a variety of shapes and sizes, and is not limited to the embodiments described herein.

In some cases, the distal end of the spout 1 can be at the same height, or above the height of the lip 14 of the sidewall 12. This can be advantageous in that liquids contained within the cavity 15 of the container body 7 will be unable to escape via the spout 1 unless the container body 7 is rotated (e.g., about a vertical axis that is perpendicular to the bottom of the container when resting on a flat surface).

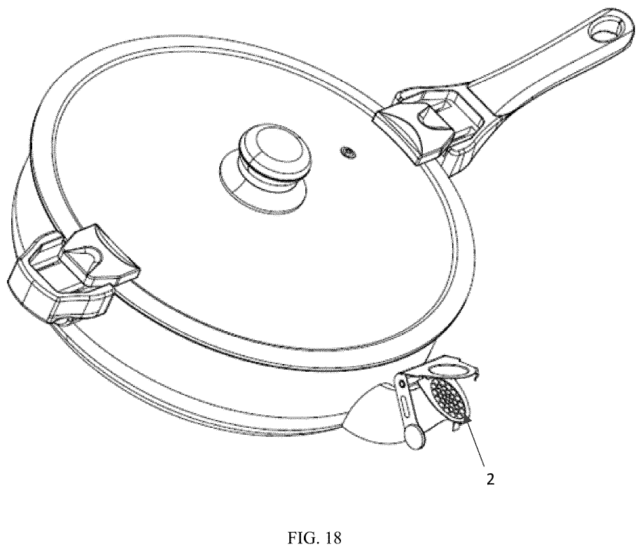

The spouted container can also include a mesh screen 2. The mesh screen 2 can include a number of apertures that can allow the passage of liquid, but not solids. In some cases the mesh screen 2 can be composed of a food-grade material, such as copper, aluminum, or steel. The mesh screen 2 can keep any solids within the spouted container, yet can allow the liquids contained within the spouted container to be drained via the spout 1 (e.g., via rotation of the spouted container). The mesh screen 2 can be coupled to the proximal end of the spout 1, the immediately defining sidewall 12, or both. For example, the mesh screen 2 can be welded to the interior surface of the sidewall 12, bolted to the sidewall 12, glued to the sidewall 12 (e.g., with adhesive), and the like. In some cases, the outer perimeter of the mesh screen 2 can be an O-ring, which can be sealed onto a corresponding portion of interior sidewall 12 surface, or an interior surface of the spout 1 (e.g., ridges and corresponding valleys). Examples of the mesh screen 2 being positioned within the spout 1 may be useful in the cases where the proximal end of the spout 1 extends into the cavity 15 of the spouted container. Alternatively, the mesh screen 2 can be disposed at the distal end of the spout 1, for example via welding or an adhesive. FIG. 18 depicts a mesh screen 2 hingeably coupled to the distal end of a spout 1. For example, the mesh screen 2 may be locked to the distal end of the spout 1, such that when the container body is rotated, the pivoting cover can rotate away from the spout's distal end, but the mesh screen stays in place when locked. When the mesh screen 2 is unlocked from the distal end of the spout 1, the mesh screen may likewise rotate (around the hinge point) away from the distal end of the spout 1. This can be used, for example, if a user desires to keep solids within the container while allowing liquids to drain from the spout when rotating the container. Alternatively, if the user wishes for both solid and liquids to drain from the container, the mesh screen 2 can be unlocked form the spout distal end, which can allow the mesh screen to hingeably rotate away from the spout distal end when rotated. In either case, a pivoting cover 3 can cover the mesh screen 2 and the distal end of the spout, and can hinge away from the distal end of the spout when the container, regardless of whether the mesh screen is locked or unlocked form the distal end of the spout.

In some cases, the mesh screen 2 can be removable from the spouted container. For example, in cases where the mesh screen 2 is temporarily coupled to the spout 1 or the container body 7, the mesh screen 2 may be removed. For example, where the mesh screen 2 is coupled via tension, adhesive, and the like, the mesh screen 2 may be removed. This may be beneficial for cleaning purposes, such as for cleaning debris caught in the mesh screen 2, or in some cases to replace the mesh screen with another mesh screen.

The spouted container can also include a pivoting cover 3. The pivoting cover 3 can be configured to couple to an exterior surface of the spout 1. The pivoting cover 3 can be coupled to the spout 1 via a hinge. The pivoting cover 3 can include a cap configured to cover the distal portion of the spout 1 when in a resting position (e.g., when the container bottom is perpendicular to a vertical axis described above). The pivoting cover 3 can also include one or more counterbalances coupled to the cap. The counterbalances can be coupled to the cap, and can be positioned such that the counterbalances are below the cap and between the body of the spout 1 and the container body 7. When the container body 7 is in a resting position (e.g., the bottom surface 11 of the container body 7 is perpendicular to the gravitational force exerted on the spouted container), the pivoting cover 3 can be coupled to (e.g., be in contact with) the distal end of the spout 1. When the spouted container is rotated (e.g., the bottom surface 11 of the container body 7 is not perpendicular to the gravitation force exerted on the spouted container), the pivoting cover 3 can hinge away from the distal end of the spout 1, thereby allowing liquids to be drained from the container body 7. Likewise, when the spouted container is rotated, the counterbalances can rotate away from the body of the spout 1 and towards the container body 7. In some cases, the pivoting cover 3 can be configured such that the counterbalances contact the container body 7 and a particular angle, such that the cap of the pivoting cover has a maximum hinge angle away from the spout opening. In this way, the counterbalances can prevent the pivoting cover from flipping over, which, if this occurs, can prevent the pivoting cover from covering the spout end once the container is placed back into a resting position.

The spouted container can include a lid 6. The lid 6 can be relatively the same size and shape as the sidewall lip 14 formed by the container body 7. In some cases, the lid 6 perimeter can be slightly larger than the perimeter of the sidewall lip 14. In some cases, the outer edge of the lid 6 can include a set of grooves configured to couple to the sidewall lip 14. The outer edge of the lid 6 can be composed of a rubber, polyurethane, and the like, and in a preferred embodiment is formed of a material that can withstand the heat of cooking without degrading. The body of the lid 6 can be composed of tempered glass, copper, steel, and the like.

The spouted container can also include a handle 4. The handle 4 can be coupled to the lid 6, and can be configured to lift the weight of the lid 6 by a user.

The spouted container can also include a lid lock mechanism 5. The lid lock mechanism can be coupled to the lid 6 and can engage the container 7 to further couple the lid 6 to the container body 7. For example, the lid lock mechanism 5 can include a protrusion that can engage with a corresponding protrusion or retrusion of a handle 8 of the container body 7. When engaged, the lid 6 can be statically coupled to the sidewall lip 14 until the lid lock mechanism is disengaged.

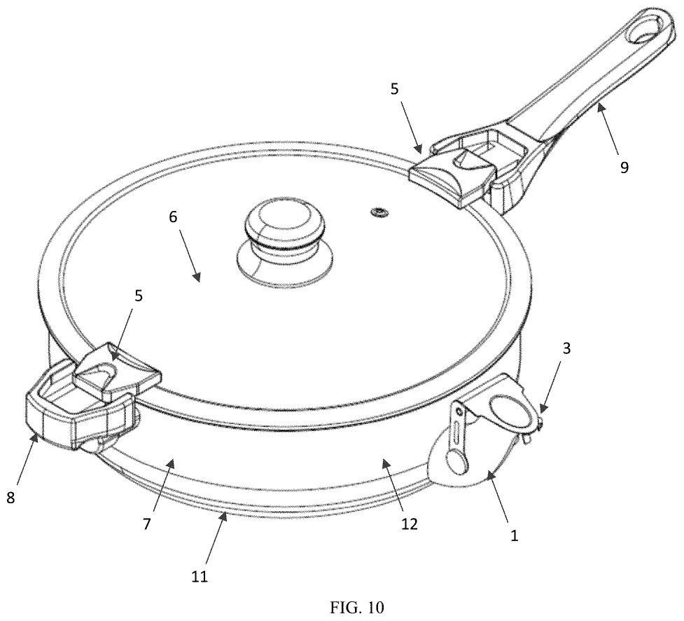

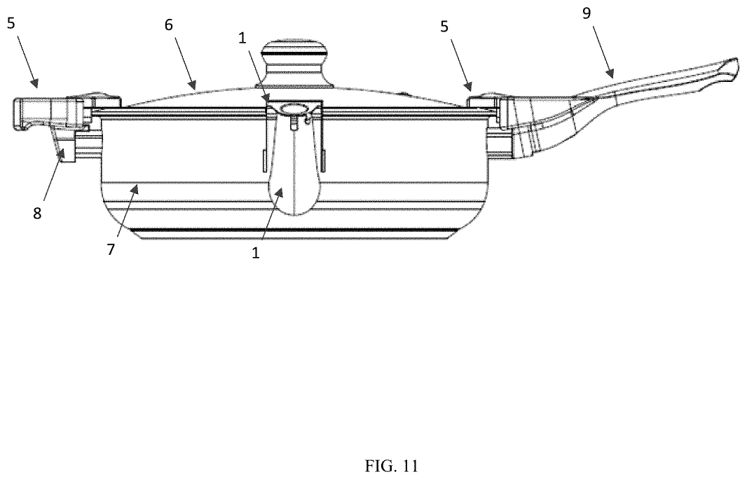

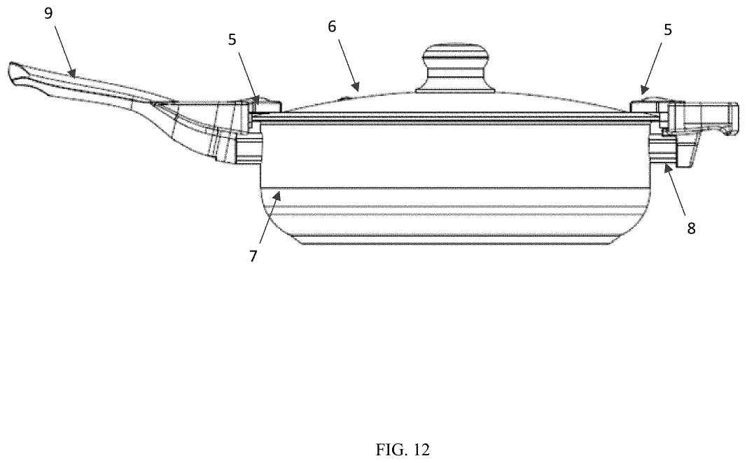

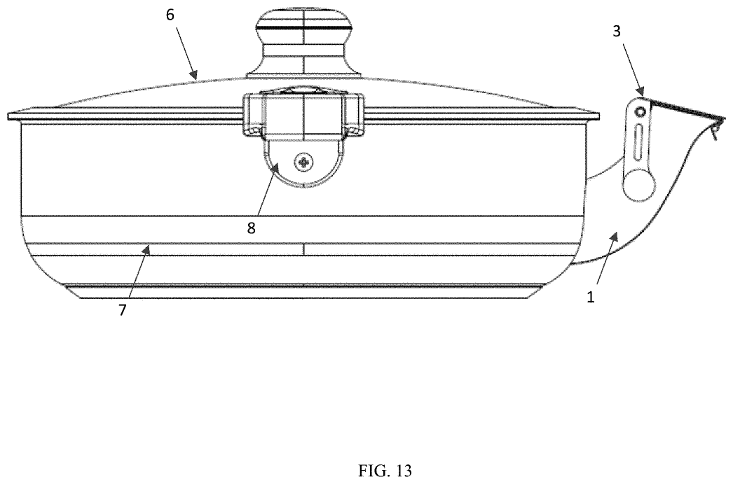

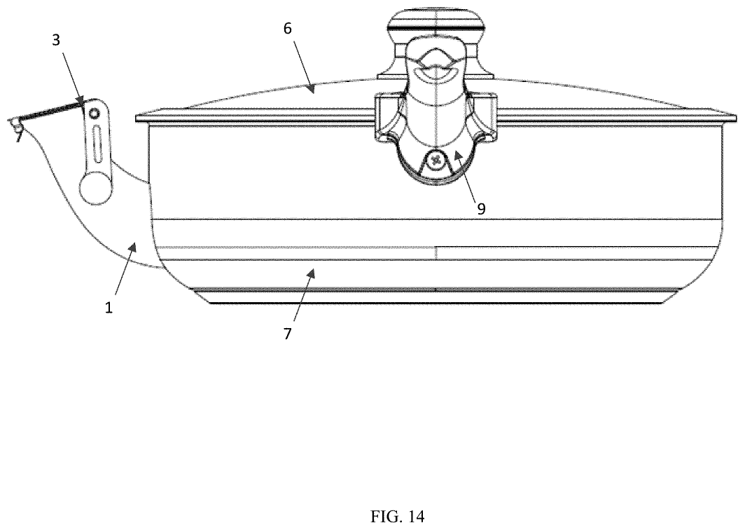

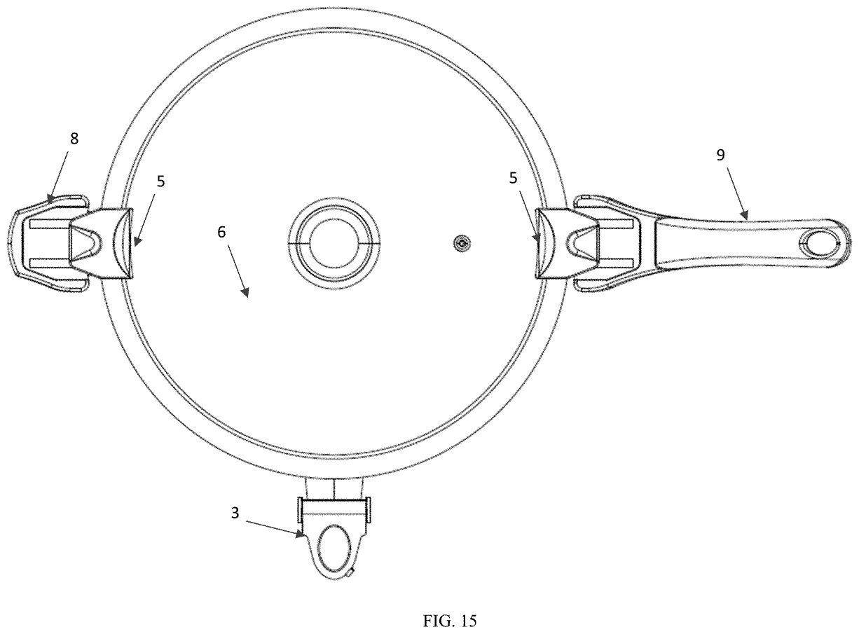

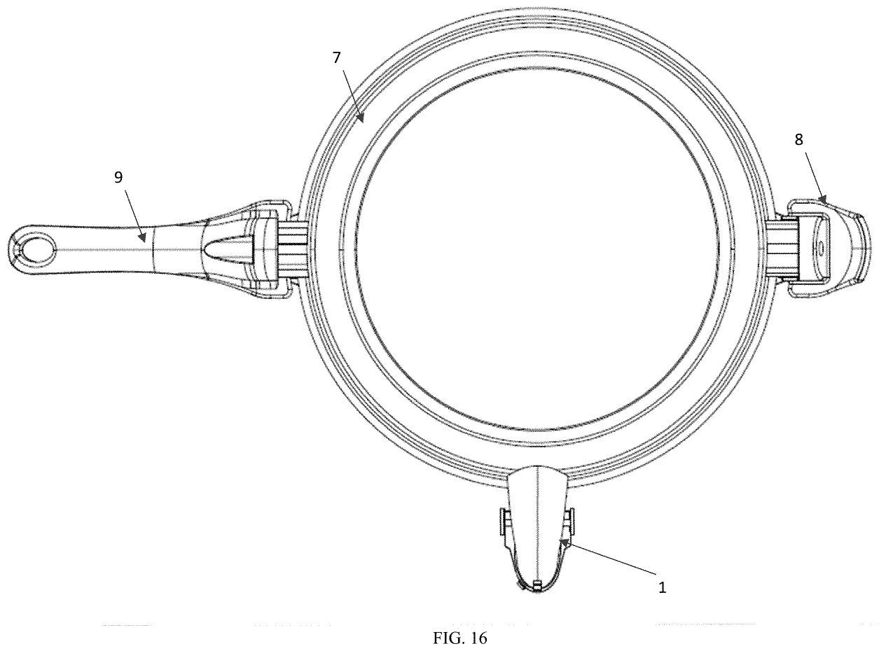

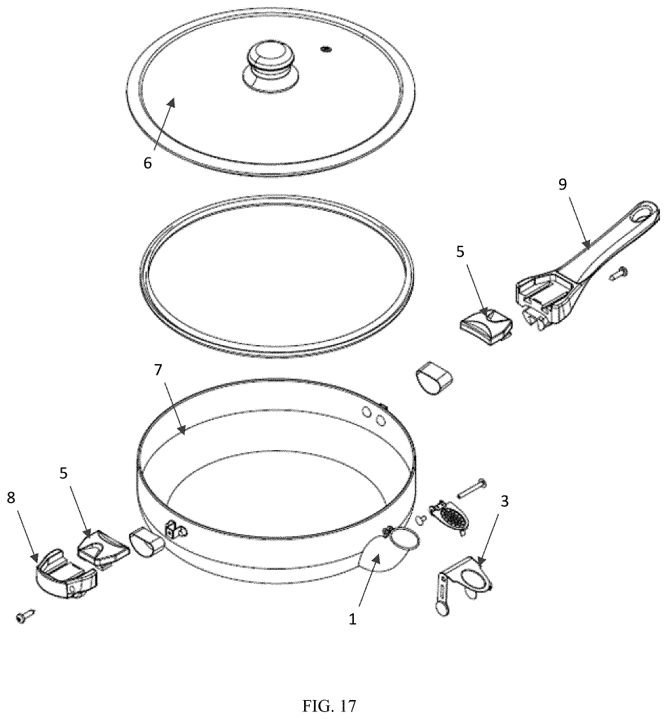

In some cases, the spouted container can include multiple lid lock mechanisms 5 (e.g., two mechanisms 5 that are 180 degrees apart from one another along the surface of the lid 6). In some cases, the lid locking mechanism 5 can be incorporated into a handle 8 coupled to the container body 7, an embodiment of which is depicted in FIGS. 10-18. The handle 8 can include a sliding portion that can slide overtop the lip of the lid 6 when the lid is positioned on the container body 7, and in some cases can lock in place (e.g., such that the sliding portion cannot automatically or mistakenly unlock). The sliding portion can thus lock the lid 6 to the container body 7.

The spouted container can also include a container handle 9. The container handle 9 can be coupled to the container body 7 and can be configured to carry the weight of the container body with or without the lid 6. In some cases, the top profile of the container handle 9 can be configured to receive, or be received by, a lower profile of the handle 4 of the lid 6. Thus, in some cases, the container handle 9 and the handle 4 can facilitate coupling of the lid 6 to the container body 7.

### How the Spouted Container Works:

The following discussion describes the spouted container as a cooking device, such as a cooking pan or pot. The cooking pan body can cook food containing grease and or other hot liquids. The spout and mesh screen can allow the hot liquids to safely and easily drain from the cooking pan body when the cooking pan is tilted. Furthermore, the lid, in conjunction with the lid handle and lid lock, can lock liquids and food safely in the cooking pan when the lid lock mechanism is engaged with the corresponding base lid lock. The user can tilt the pan, which can drain grease, water, and other liquids out of the pan without having to remove the lid. This can allow the user to continue cooking or using the pan without using a colander. Additionally, the food stays in the pan when the lid is locked, while passing any liquids such as grease through the spout. Thus, the cooking pan presents a safe and convenient way for a user to cook without having to use several pans or potentially get burned when pouring out hot liquids the traditional way through the top of the pan.

### How to Make the Spouted Container:

The following discussion discloses a method for manufacturing the spouted container. The example discusses the manufacture of a spouted cooking pot. However, the disclosure is not limited to this example, and cover different container bodies such as paint cans, and the like.

Cut or etch an aperture into a sidewall of a cooking container, such as a pan or pot. Insert a proximal end of a spout into the aperture, or place the spout in contact with the portions of the sidewall immediately defining the aperture. Weld, bolt, thread, couple, and the like, the proximal end of the spout to the sidewall portions immediately defining the aperture. Alternatively, cast the cooking container body with the spout (e.g., as one unit). Couple a pivoting cover to the cooking container sidewall (e.g. via a hinge). Couple a mesh screen to the aperture (e.g., via welding, adhesive, contact pressure, etc.) to prevent food from spilling out through the spout.

Couple the handle to the lid, the container handle to the container sidewall, the lid lock mechanism to the lid, and the protrusion or retrusion to the container sidewall, for example by bolts, welding, screws, and the like.

### How to Use the Spouted Container:

A person can use the spouted cooking pot/pan to cook any food that creates grease or requires boiling hot water as in the case of bacon or pasta. The user can simply drain out the grease or water by optionally locking the lid and tilting the pan slightly to engage the spout. If desired, to minimize spillage over the lipped edge (or whatever you called it) when pouring, the lid 6 can be locked to the container body 7 via the lid lock mechanism 5, the handle 8, or both. Additionally, the user can pour out soups and sauces directly onto a dinner plate bypassing the use of spoons, ladles, gravy boats, etc.

In some cases, the spouted container can be used in medical labs for draining liquids from other devices.

We claim:

1. A spouted container comprising:
a container body having a bottom surface and a sidewall, wherein the bottom surface and the sidewall define a cavity, wherein the sidewall further defines an aperture;
a spout coupled to the sidewall via a proximal end and in fluidic communication with the cavity via the aperture; and
a mesh screen coupled to the sidewall and positioned to encompass the aperture.

2. The spouted container of claim 1, wherein the sidewall terminates at an edge distally away from the bottom surface.

3. The spouted container of claim 2, further comprising:
a lid configured to be coupled to the edge of the sidewall.

4. The spouted container of claim 3, further comprising:
a pivoting cover coupled to the lid via a hinge, wherein the pivoting cover is configured to contact a distal end of the spout when the lid is coupled to the container body and the spouted cooking pan is in a resting position.

5. The spouted container of claim 4, wherein the pivoting cover is further configured to cease contacting the distal end of the spout when the lid is coupled to the container body and the spouted container is in a draining position.

6. The spouted container of claim 5, wherein the draining position comprises a rotation of the container such that the distal end of the spout is at a lower height than the edge of the sidewall.

7. The spouted container of claim 3, further comprising a lid locking mechanism coupled to the lid, wherein the lid locking mechanism is configured to engage a corresponding locking mechanism coupled to the container body when the lid is coupled to the edge of the sidewall, and wherein the lid is secured to the container body when the lid locking mechanism is engaged with the corresponding locking mechanism.

8. The spouted container of claim 1, wherein the bottom surface and sidewall are composed of a non-stick, food-grade material.

9. The spouted container of claim 1, wherein the container body comprises a cooking pan or a cooking pot.
